(19) United States
(12) Patent Application Publication
(10) Pub. No.: US 2025/0060502 A1
(43) Pub. Date: Feb. 20, 2025

(54) METHOD FOR MEASURING SPECTRUM PARAMETERS OF FORMATION OUTCROP AND ROCK MASS

(71) Applicant: HUNAN UNIVERSITY OF SCIENCE AND TECHNOLOGY, Xiangtan (CN)

(72) Inventors: Hui CHENG, Xiangtan (CN); Guohong FU, Xiangtan (CN); Yan LIU, Xiangtan (CN); Xiuying LIAO, Xiangtan (CN)

(21) Appl. No.: 18/937,177

(22) Filed: Nov. 5, 2024

(30) Foreign Application Priority Data
May 29, 2024 (CN) 202410678472.6

(51) Int. Cl. G01V 3/08

(52) U.S. Cl. CPC G01V 3/083; G01V 2003/084; G01V 2003/085

(57) ABSTRACT

A device and method for measuring spectrum parameters of a formation outcrop and a rock mass are provided. An excitation signal is generated by a direct digital synthesis (DDS) module of a signal transmission portion. A constant voltage mode or a constant current mode is adopted for observation. After the signal passes through a constant voltage/constant current module, a constant high-voltage signal source or a current source signal with constant current output is formed and output to ground through grounding electrodes A and B to establish a stable observation signal field source. Geoelectric response information under the excitation of each frequency signal is acquired by a signal receiving portion through grounding electrodes M and N, processed and send out to a microcontroller unit (MCU) for display and storage. The spectrum parameters at different depths are observed by adjusting geometric dimensions of AB and MN.

### CROSS-REFERENCE TO RELATED APPLICATIONS

This application claims the benefit of priority from Chinese Patent Application No. 202410678472.6, filed on May 29, 2024. The content of the aforementioned application, including any intervening amendments made thereto, is incorporated herein by reference in its entirety.

### TECHNICAL FIELD

This application relates to exploration geophysics, and more particularly to a device and method for measuring spectrum parameters of a formation outcrop and a rock mass.

### BACKGROUND

As a basic condition for electrical (magnetic) exploration, the electrical parameters of formations/rock masses generally include resistivity, polarizability, and spectrum data of a certain bandwidth. In the prior art, the resistivity and polarizability of the formation outcrops and rock masses in the area are acquired in situ with a small quadrupole device. According to the requirements of the “Technical specifications for rock spectrum induced polarization measurement” (SY/T7485-2020), it is necessary to conduct spectrum experiments on rock samples in the frequency range of 0.01-1000 Hz to acquire the amplitude-frequency and phase-frequency data of the rock samples, and calculate the resistivity, polarizability, time constant and frequency correlation coefficient based on the corresponding conductive model. Both the in-situ observation results and the experimental data of indoor rock samples are adopted to support the establishment of geological-geophysical models, the selection of exploration methods and the geological interpretation of geophysical data. The resistivity, polarizability and corresponding spectral parameters of formation outcrops and rock masses are the bridge among exploration methods, forward and inverse calculations and geological factors, and are the link for the trinity of exploration method practice, observation data and geological interpretation. Therefore, the electrical characteristics and conductive mechanism of regional rocks are an important research field in electrical (magnetic) methods.

In order to complete the resistivity and polarizability measurement of the formation outcrops and rock masses in the exploration area, a direct current (DC) observation scheme can be used, such as a DC digital electric meter and a DC resistivity meter. A dual-frequency induced polarization observation scheme can also be selected, such as using the sending current and receiving voltage recorded by the dual-frequency induced polarization instrument to calculate the corresponding resistivity and polarizability. Whether the DC observation scheme or the dual-frequency induced polarization observation scheme is adopted, the final result is only a single resistivity value and polarizability value of the formation outcrop or rock mass. There is no dedicated measurement equipment for the measurement of the spectrum parameters of rock specimens in the prior art. Spectrum analyzers, impedance analyzers, inductance-capacitance-resistance (LCR) meters, etc. are generally used for indoor specimen observation experiments. However, these are mainly observation equipment developed for centralized parameter devices. Due to the limitations of design principles, they can only perform spectrum measurements of rock samples indoors, rather than in-situ measurements of formation outcrops and rock masses.

The observation results of both the DC device and the frequency domain device are resistivity and polarizability values, which have relatively little available information. The indoor spectrum measurement of rock specimens is essentially to use the observation values of small specimens to map the spectrum electrical characteristic parameters of large specimens with the earth as the background. However, the collection and cutting of rock specimens inevitably destroys the structural state under the original conditions. At the same time, the immersion solution is also different from that in the in-situ state. The observation data only reflects the approximate conductive characteristics of the formation and rock mass in the collection area. Ultimately, the corresponding laws are statistically calculated through a certain amount of observational experimental data to map out the conductivity laws of the area. This is a relatively complex and time-consuming method that requires a certain amount of observational data to obtain the corresponding statistical laws.

### SUMMARY

In order to solve the problems in the prior art, this application provides a device and method for measuring spectrum parameters of a formation outcrop and a rock mass. Technical solutions of the present disclosure are described as follows.

In a first aspect, this application provides a device for measuring spectrum parameters of a formation outcrop and a rock mass, comprising:
a signal transmission portion; and
a signal receiving portion;
wherein the signal transmission portion comprises a grounding electrode A, a grounding electrode B, a microcontroller unit (MCU), a direct digital synthesis (DDS) module, a polarity conversion module, a signal amplification module, a mode switching module, a constant voltage/constant current module, a power amplification module and a current acquisition module; the MCU, the DDS module, the polarity conversion module, the signal amplification module, the mode switching module, the constant voltage/constant current module and the power amplification module are connected in sequence; an output signal of the power amplification module is configured to be output to ground through the grounding electrode A and the grounding electrode B to form a first transmission loop circuit; an input end of the current acquisition module is connected to the power amplification module, and an output end of the current acquisition module is connected to the MCU; a frequency signal generated by the signal transmission portion is configured to be sequentially subjected to polarity conversion, signal amplification and connection to the grounding electrode A and the grounding electrode B to form a second transmission loop circuit; and the current acquisition module is configured to record information about output voltage, current and time of each frequency point to the MCU in real time; and
the signal receiving portion comprises a grounding electrode M, a grounding electrode N, a pre-amplification module, a notch/pass-through module, a bandpass filtration module, a programmable gain amplification module and an analog-digital converter (ADC) module; the grounding electrode M and the grounding electrode N are connected to the pre-amplification module; the pre-amplification module, the notch/pass-through module, the bandpass filtration module, the programmable gain amplification module, the ADC module and the MCU are connected in sequence; the signal receiving portion is configured to acquire a frequency response signal of an underground medium through the grounding electrode M and the grounding electrode N, such that the frequency response signal is sequentially subjected to signal pre-amplification, signal conditioning, ADC conversion and post-processing by the MCU, so as to form spectrum characteristic information of the formation outcrop or the rock mass within a preset frequency bandwidth.

In some embodiments, the device further comprises:
a communication module;
a display module;
a keyboard module; and
a storage module;
wherein the MCU is connected to the communication module, the display module, the keyboard module and the storage module.

In some embodiments, the signal transmission portion is configured to generate an excitation signal at a frequency point of 2ⁿ Hz, and n is an integer selected from −7 to 10; a 0.5-time frequency within the preset frequency bandwidth is configured to perform frequency encryption among each frequency point; and a final signal frequency range is 0.01 Hz-1 kHz.

In some embodiments, the signal transmission portion is in a common clock mode with the signal receiving portion, such that signal transmission and signal receiving are completed based on the common clock mode, thereby detecting amplitude frequency information and phase frequency information of the formation outcrop or the rock mass on the basis of improving an anti-interference capability.

In some embodiments, the grounding electrode A, the grounding electrode B, the grounding electrode C and the grounding electrode D are arranged according to a symmetrical quadrupole arrangement, such that the spectrum parameters of the formation outcrop or the rock mass at different depths within a preset depth range are observed by changing a geometric dimension of the grounding electrode A, the grounding electrode B, the grounding electrode C and the grounding electrode D.

In a second aspect, this application provides a method for measuring spectrum parameters of a formation outcrop and a rock mass using the above device, comprising:
(1) selecting the formation outcrop or the rock mass as an observation object according to an exploration target requirement and a working area; lowering a grounding resistance of the grounding electrode A and the grounding electrode B by watering; connecting a first connecting wire to the grounding electrode A and the grounding electrode B to form a first connecting loop; measuring a first resistance value of the first connecting loop to estimate an output constant current or an output constant voltage; arranging the grounding electrode M and the grounding electrode N according to a requirement of a symmetrical quadrupole arrangement; connecting the grounding electrode M to a terminal of an M port of the device through a second connecting wire; and connecting the grounding electrode N to a terminal of an N port of the device through the second connecting wire to form a second connecting loop;
(2) connecting an external direct current (DC) power supply to an input end of the power amplification module followed by polarity correctness check; and connecting the first connecting wire to terminals of an output end A and an output end B of the power amplification module;
(3) powering on the device for preheating; and checking a connection status of the input end, the output end A and the output end B of the power amplification module, the grounding electrode A, the grounding electrode B, the grounding electrode M, the grounding electrode N, the first connecting wire and the second connecting wire; measuring a second resistance value of the first connecting loop; checking a connection status of the second connecting wire, the grounding electrode M and the grounding electrode N; measuring a resistance value of the second connecting loop;
(4) after preheating the device for 5 min, generating and transmitting, by the signal transmission portion, a 1 Hz excitation signal, and observing and calculating a resistivity value of the observation object at this time; adjusting, by the signal transmission portion, an intensity of the output constant voltage or the output constant current; and sending out, by the signal transmission portion, each frequency point signal in the preset frequency bandwidth set by a frequency table in sequence;
(5) picking up, by the signal transmission portion, the frequency response signal followed by checking to conform that the frequency response signal is normal; and starting acquisition;
(6) saving information of each frequency point received by the signal receiving portion and current information sent by the signal transmission portion in the storage module; and
(7) performing mapping processing in an upper computer followed by corresponding geological interpretation.

In some embodiments, in step (1), in a case where the observation object is a complete rock mass, a dough with a saturated copper sulfate solution is adopted as a coupling material coupled to the grounding electrode A, the grounding electrode B and the complete rock mass, thereby lowering the grounding resistance.

Compared with the prior art, this application has the following beneficial effects.

(1) The signal transmission portion and the signal receiving portion of the present disclosure are designed in a common clock mode. The signal generated by the signal transmission portion is introduced into the ground via the grounding electrode A and the grounding electrode B to form a stable exploration signal field source. The frequency response signal of the ground electric field is picked up by the grounding electrode M and the grounding electrode N, and send out to the MCU for subsequent processing. The observational data stored in the device is later processed, calculated and mapped by the upper computer accordingly to form the spectrum parameters of the formation outcrop or the rock mass at the observation point. This provides a basic electrical support for the subsequent establishment of a geological-geophysical model, the selection of geophysical methods and the geological interpretation of geophysical data.

(2) In the present disclosure, within the bandwidth of 2⁻⁷ Hz to 210 Hz, the excitation signal of 18 frequency points with 2 as a base and an integer of −7 to 10 as an exponent is formed to cover the frequency signal of 0.01 Hz-1 kHz. The frequency points can be encrypted with the 0.5-time frequency. A Frequency-domain excitation signal adopts a current/voltage mode to pass through the grounding electrode A and the grounding electrode B to form an excitation output signal. The frequency response signal of the underground medium is received by the signal receiving portion through the grounding electrode M and the grounding electrode N. A weak signal detection technique is adopted to design precise pre-amplification, signal conditioning and ADC conversion to improve a signal-to-noise ratio. A coherent detection method is adopted to improve the observation accuracy by means of the common clock mode between the signal transmission portion and the signal receiving portion. The data of the signal receiving portion is mapped and analyzed by the upper computer, so as to solve the problem in the prior art that it fails to realize in-situ measurement of the spectrum parameters of the formation outcrop and the rock mass.

### BRIEF DESCRIPTION OF THE DRAWINGS

FIG. 1 is a block diagram of a device for measuring spectrum parameters of a formation outcrop and a rock mass in accordance with an embodiment of the present disclosure;

FIG. 2 shows an amplitude frequency plot of checkpoint consistency comparison in accordance with an embodiment of the present disclosure;

FIG. 3 shows a phase frequency plot of the checkpoint consistency comparison in accordance with an embodiment of the present disclosure;

FIG. 4 shows a symmetric quadrupole sounding diagram in accordance with an embodiment of the present disclosure; and

FIG. 5 shows a spectrogram when AB is 6 m and 9 m in accordance with an embodiment of the present disclosure.

### DETAILED DESCRIPTION OF EMBODIMENTS

The present disclosure will be further described below in conjunction with the accompanying drawings and embodiments.

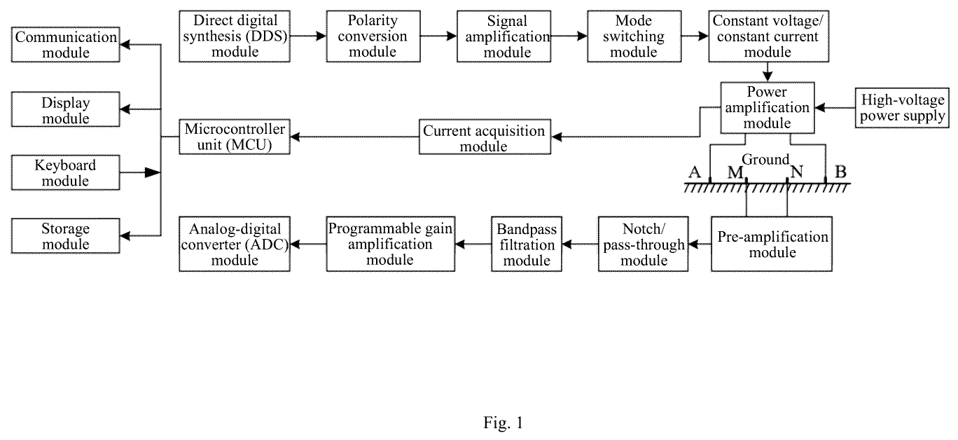

As shown in FIG. 1, a device for measuring spectrum parameters of a formation outcrop and a rock mass is provided, including a signal transmission portion, a signal receiving portion, a communication module, a display module, a keyboard module and a storage module.

The signal transmission portion includes a grounding electrode A, a grounding electrode B, a microcontroller unit (MCU), a direct digital synthesis (DDS) module, a polarity conversion module, a signal amplification module, a mode switching module, a constant voltage/constant current module, a power amplification module and a current acquisition module. The MCU, the DDS module, the polarity conversion module, the signal amplification module, the mode switching module, the constant voltage/constant current module and the power amplification module are connected in sequence. An output signal of the power amplification module is configured to be output to ground through the grounding electrode A and the grounding electrode B to form a first transmission loop circuit, so as to provide a stable exploration signal field source. An input end of the current acquisition module is connected to the power amplification module, and an output end of the current acquisition module is connected to the MCU. A frequency signal generated by the signal transmission portion is configured to be sequentially subjected to polarity conversion, signal amplification and connection to the grounding electrode A and the grounding electrode B to form a second transmission loop circuit. The current acquisition module is configured to record information about output voltage, current and time of each frequency point to the MCU in real time.

The functions of each module in the signal transmission portion are as follows. The DDS module is configured to generate an excitation signal with 18 frequency points with a base of 2 and an integer index of −7 to 10 in a frequency band ranging from 2⁻⁷ Hz to 210 Hz. The excitation signal is sent to the polarity conversion module. The polarity conversion module is configured to convert a unipolar signal generated by the DDS module into a bipolar signal. Subsequentially, the bipolar signal is sent to the signal amplification module for amplification, and then switched a constant voltage mode and a constant current mode through the mode switching module. The constant voltage mode or the constant current mode is selected according to working requirements. After selecting the working mode, the excitation signal enters the power amplification module, and is further subjected to power amplification by different circuits. A high-voltage or high-current signal power output to the ground is provided by an external high-voltage power supply.

The MCU is connected to the communication module, the display module, the keyboard module and the storage module. The communication module is configured for use when the device uploads data to a personal computer. The display module is mainly composed of liquid crystal, and is configured to display a status of the device and monitor the observation after startup. The keyboard module is configured for human-computer interaction of the device. The storage module is configured to save observation data.

The signal receiving portion includes a grounding electrode M, a grounding electrode N, a pre-amplification module, a notch/pass-through module, a bandpass filtration module, a programmable gain amplification module and an analog-digital converter (ADC) module. The grounding electrodes M and N are connected to the pre-amplification module. The pre-amplification module, the notch/pass-through module, the bandpass filtration module, the programmable gain amplification module, the ADC module and the MCU are connected in sequence. The signal receiving portion is configured to acquire a frequency response signal of an underground medium through the grounding electrodes M and N, such that the frequency response signal is sequentially subjected to signal pre-amplification, signal conditioning, ADC conversion and post-processing by the MCU, so as to form spectrum characteristic information of the formation outcrop or the rock mass within a preset frequency bandwidth.

The functions of each module in the signal receiving portion are as follows. The grounding electrodes M and N are configured to acquire frequency response information of the underground medium. The pre-amplification module is configured to amplify a weak response signal for a first time. A notch in the notch/pass-through module is configured to remove a 50 Hz signal and a third harmonic signal thereof in the frequency band, and a pass-through in the notch/pass-through module is configured to unprocess a power frequency fundamental wave and a third harmonic. The bandpass filtration module is configured to filter out an out-of-band signal. The programmable gain amplification module is a main amplification module of the device, such that the signal within the entire frequency band reaches the strength required by the subsequent modules.

The excitation signal with frequency points with a base of 2 and an integer index of −7 to 10 in the frequency band ranging from 2⁻⁷ Hz to 210 Hz is generated by the signal transmission portion. A 0.5-time frequency can be selected within the frequency band for encryption among each frequency point. A final signal frequency range is 0.01 Hz-1 kHz.

The signal transmission portion is in a common clock mode with the signal receiving portion, such that signal transmission and signal receiving are completed based on the common clock mode, thereby detecting amplitude frequency information and phase frequency information of the formation outcrop or the rock mass on the basis of improving an anti-interference capability.

The grounding electrodes A, B, C and D are arranged in a symmetrical quadrupole arrangement, such that the spectrum parameters of the formation outcrop or the rock mass at different depths within a preset depth range are observed by changing a geometric dimension of the grounding electrodes A, B, C and D.

A method for measuring spectrum parameters of a formation outcrop or a rock mass using the above device is provided, which includes the following steps.

Step (1) A formation outcrop or rock mass is selected as an observation object according to an exploration target requirement and formation outcrop and rock mass information in a working area. A grounding resistance of the grounding electrodes A and B is lowered by watering. Specifically, when the observation object is a rock mass which is weathered, broken, or contains gravel (sand)-containing deposits, the grounding electrodes A and B can be hammered in and then moistened with salt water, thereby ensuring signal transmission and reception. When the observation object is a complete rock mass which is not broken or weathered, a dough with a saturated copper sulfate solution is adopted as a coupling material coupled to the grounding electrode A, the grounding electrode B and the complete rock mass, thereby lowering the grounding resistance. A first connecting wire is connected to the grounding electrode A and the grounding electrode B to form a first connecting loop. A first resistance value of the first connecting loop is measured to estimate an output constant current or an output constant voltage. The grounding electrode M and the grounding electrode N are arranged according to a requirement of a symmetrical quadrupole arrangement. The grounding electrode M and the grounding electrode N are respectively connected to terminals of an M port and an N port of the device through the second connecting wire to form a second connecting loop.

Step (2) An external direct current (DC) power supply is connected to an input end of the power amplification module followed by polarity correctness check. The first connecting wire is connected to terminals of an output end A and an output end B of the power amplification module.

Step (3) The device is powered on for preheating. A connection status of the input end, the output end A and the output end B of the power amplification module, the grounding electrode A, the grounding electrode B, the grounding electrode M, the grounding electrode N, the first connecting wire and the second connecting wire is checked. A second resistance value of the first connecting loop is measured. A connection status of the second connecting wire, the grounding electrode M and the grounding electrode N is checked. A resistance value of the second connecting loop is measured.

Step (4) After preheating the device for 5 min, a 1 Hz excitation signal is generated and transmitted by the signal transmission portion, and a resistivity value at this time is observed and calculated. An intensity of the output constant voltage or the output constant current is adjusted by the signal transmission portion, and each frequency point signal in the preset frequency bandwidth set by a frequency table is sent out in sequence by the signal transmission portion.

Step (5) The frequency response signal is picked up by the signal transmission portion and then checked to conform that the frequency response signal is normal. The acquisition is started.

Step (6) Information of each frequency point received by the signal receiving portion and current information sent by the signal transmission portion are saved in the storage module.

Step (7) Mapping processing is performed in an upper computer, and then corresponding geological interpretation is made.

Generally, electrical parameter measurement data of the formation outcrop or rock mass has different forms according to different excitation field sources. For example, if a DC power supply is used for excitation, the resistivity value of the formation outcrop or rock mass can be obtained; if time domain induced polarization (IP) signal excitation is adopted, a polarizability value of the formation outcrop or rock mass can be obtained, and the resistivity value can be obtained according to the transmitted current, the received voltage and the device coefficient of the measuring device; and if dual-frequency signal excitation is adopted, an amplitude frequency (the polarizability value) of the formation outcrop or rock mass can be obtained, and the resistivity value can be obtained according to the transmitted current, the received voltage and the device coefficient of the measuring device. However, the measurement of in-situ spectrum parameters of stratum outcrops/rock masses with a certain bandwidth has not been publicly reported yet. The spectrum parameter observation scheme for rocks and minerals in the prior art adopts the method of collecting rock and mineral samples to observe the spectrum parameters with a certain bandwidth indoors. The indoor observation regulation requires a frequency band of 0.01 Hz-1 kHz. The signal source of the present disclosure should meet the following requirements. 1) The frequency band covers the range required by the regulation. 2) The transmitted signal needs to be selectable between constant voltage and constant current. 3) The electromagnetic interference may exist in the observation area, which requires the device to have a certain interference capability.

In view of the above three requirements, the present disclosure adopts a direct digital frequency synthesizer to generate a frequency signal covering 0.01 Hz-1 kHz, and 0.5-time frequency can be selected for encryption among each frequency point. The signal transmission portion adopts a separate constant voltage or constant current circuit to form an output loop with the ground electrodes to establish a stable observation field source. The same controller of the signal transmission portion and the signal receiving portion is adopted as their main control unit. The signal transmission portion and the signal receiving portion adopts a common clock synchronization method to improve the amplitude frequency and phase frequency detection accuracy, and simultaneously improve the anti-interference capability.

### EXPERIMENTAL EMBODIMENT

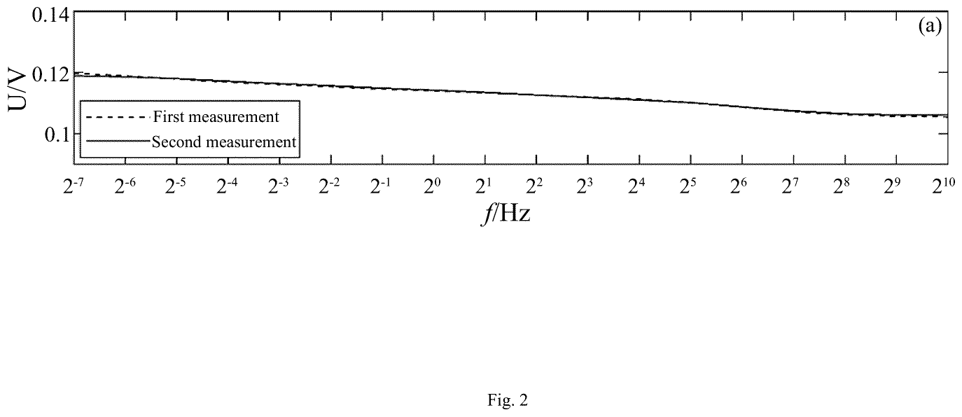

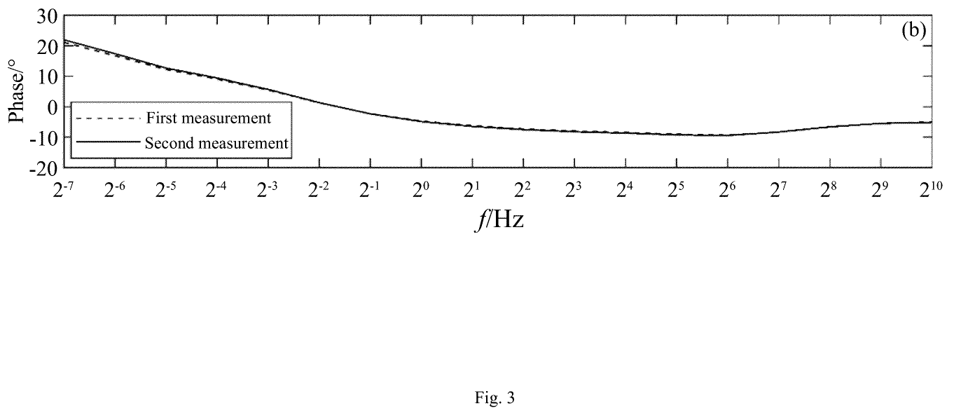

An experiment is performed at an existing Quaternary coverage area. A symmetrical quadrupole arrangement with geometric dimensions of AB=3 m and MN=1 m is adopted. An output current is acquired by output electrodes A and B through a sampling resistor. A voltage signal is acquired by electrodes M and N to obtain a transmitting current l of the electrodes A and B and a receiving voltage U of the electrodes M and N. An apparent resistivity value at each frequency point is calculated, where k is a device coefficient. At the same time, digital phase-sensitive detection is performed to obtain a phase difference between a receiving signal of the electrodes M and N and a sending signal of the electrodes A and B. The data quality of checkpoints in the observation experiment is shown in FIGS. 2-3. The observation data is shown in Table 1.

TABLE 1
Observation values at each frequency point and
deviations in the observation experiment

| Frequency | Voltage value of | Voltage value of | |
|---|---|---|---|
| 2ⁿ/Hz | first observation /V | second observation /V | Deviation |
| −7 | 0.1216 | 0.1208 | 0.0008 |
| −6 | 0.1179 | 0.1209 | 0.0030 |
| −5 | 0.1187 | 0.1175 | 0.0012 |
| −4 | 0.1173 | 0.1165 | 0.0008 |
| −3 | 0.1168 | 0.1154 | 0.0014 |
| −2 | 0.1146 | 0.1156 | 0.0010 |
| −1 | 0.1158 | 0.1148 | 0.0010 |
| 0 | 0.1140 | 0.1140 | 0 |
| 1 | 0.1133 | 0.1130 | 0.0003 |
| 2 | 0.1135 | 0.1129 | 0.0006 |
| 3 | 0.1115 | 0.1125 | 0.0010 |
| 4 | 0.1112 | 0.1108 | 0.0004 |
| 5 | 0.1096 | 0.1108 | 0.0012 |
| 6 | 0.1108 | 0.1108 | 0 |
| 7 | 0.1077 | 0.1064 | 0.0013 |
| 8 | 0.1040 | 0.1043 | 0.0003 |
| 9 | 0.1062 | 0.1059 | 0.0003 |
| 10 | 0.1058 | 0.1048 | 0.0010 |

The observation results at different points and different times on site show that the measuring device in Experimental Embodiment has high consistency. The absolute maximum difference between the two observation values is 0.3%, indicating that the observation data is credible.

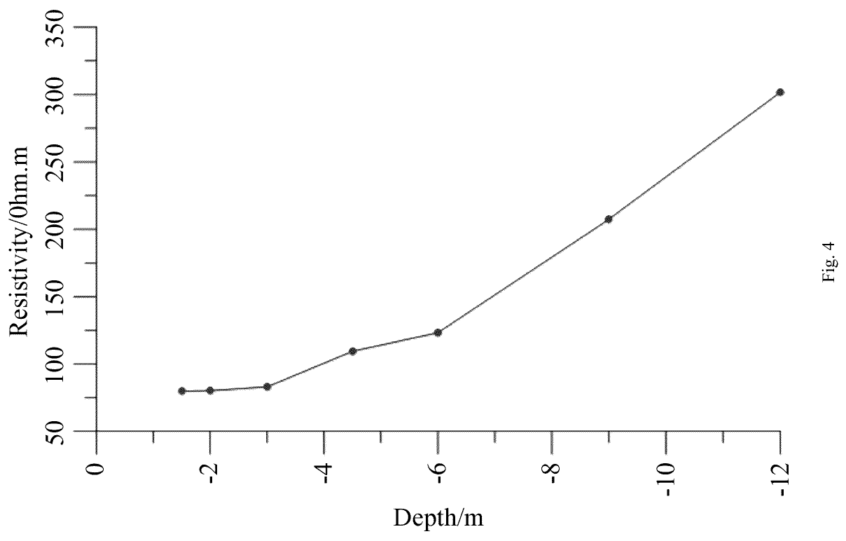

On the basis of determining the reliability of the measuring device, the spectrum observation experiment of the formation at different depths is performed according to a resistivity sounding method. That is, according to the resistivity sounding theory, an electrode spacing MN between the grounding electrodes M and N and an electrode spacing AB between the grounding electrodes A and B satisfy MN≤1/3AB, and frequency response information of an underground medium at different depths is observed by changing geometric dimensions of the electrode arrangement of the measuring device. The electrode spacings AB and MN in the experiment are shown in Table 2, where p is an apparent resistivity value at 2⁻⁷ Hz, i.e., 0.0078125 Hz. The sounding curve is shown in FIG. 4.

TABLE 2
Parameters of the measuring device and apparent
resistivity value in the observation experiment

| Geometric | | | | | | | |
|---|---|---|---|---|---|---|---|
| parameters | Observation value | | | | | | |
| AB/m | 3 | 4 | 6 | 9 | 12 | 18 | 24 |
| MN/m | 1 | 1 | 2 | 3 | 4 | 6 | 8 |
| ρ/Ω · m | 79.80 | 80.11 | 82.94 | 109.33 | 123.15 | 207.34 | 301.59 |

As shown in FIG. 4, there is no significant change in the apparent resistivity value when AB=3 m, 4 m and 6 m, which is inferred as a Quaternary cover layer; when AB=9 m, the apparent resistivity value increases significantly; and with the increase of the electrode spacing AB, the apparent resistivity value increases monotonically, presenting a G-shaped curve, which refers to a two-layer geoelectric cross-section. In FIG. 4, the electrode spacing AB is converted into the observation depth by (½ AB), that is, the resistivity at the depth of 0 m to −3 m in this area is about 80Ω·m, which is inferred as the Quaternary cover layer; the resistivity within the depth of −3 m to −12 m increases monotonically, and is in a range of [100,300]Ω·m, which is consistent with the resistivity of slate and limestone in a water-containing state. The underlying strata are slate and limestone rock masses, which is consistent with the results of local engineering drilling.

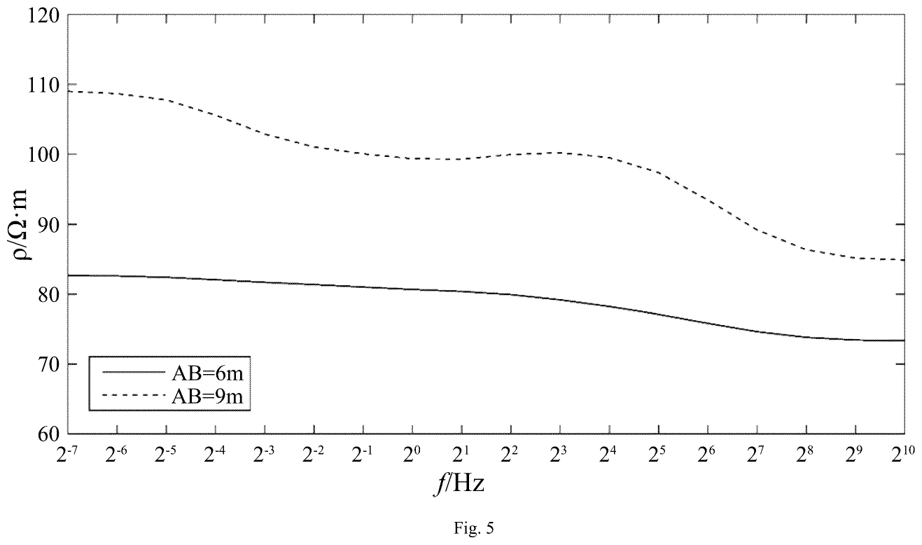

FIG. 5 shows the spectrum observation results on both sides of the depth interval where the underground medium changes. That is, in the presence of the symmetrical quadrupole arrangement, the resistivity of the formation changes significantly when AB=6 m and 9 m. Similarly, the spectrum parameters of the formation or rock mass also change at the same electrode spacing AB. As shown in FIG. 5, when AB=6 m, there is no significant change in the curve under the excitation of different frequency signals, which is stable in a low frequency band, slowly decreases in a range of 4-128 Hz, and has no significant change in a range of 128-1024 Hz; when AB=9 m, the curve obviously changes with the frequency, a regional minimum appears in a range of 0.03125-4 Hz; and as the frequency increases, the curve exhibits a trend of first rising and then falling sharply. This indicates that the underground medium at two different depths have changed.

What is claimed is:

1. A device for measuring spectrum parameters of a formation outcrop and a rock mass, comprising:
a signal transmission portion; and
a signal receiving portion;
wherein the signal transmission portion comprises a grounding electrode A, a grounding electrode B, a microcontroller unit (MCU), a direct digital synthesis (DDS) module, a polarity conversion module, a signal amplification module, a mode switching module, a constant voltage/constant current module, a power amplification module and a current acquisition module; the MCU, the DDS module, the polarity conversion module, the signal amplification module, the mode switching module, the constant voltage/constant current module and the power amplification module are connected in sequence; an output signal of the power amplification module is configured to be output to ground through the grounding electrode A and the grounding electrode B to form a first transmission loop circuit; an input end of the current acquisition module is connected to the power amplification module, and an output end of the current acquisition module is connected to the MCU; a frequency signal generated by the signal transmission portion is configured to be sequentially subjected to polarity conversion, signal amplification and connection to the grounding electrode A and the grounding electrode B to form a second transmission loop circuit; and the current acquisition module is configured to record information about output voltage, current and time of each frequency point to the MCU in real time; and
the signal receiving portion comprises a grounding electrode M, a grounding electrode N, a pre-amplification module, a notch/pass-through module, a bandpass filtration module, a programmable gain amplification module and an analog-digital converter (ADC) module; the grounding electrode M and the grounding electrode N are connected to the pre-amplification module; the pre-amplification module, the notch/pass-through module, the bandpass filtration module, the programmable gain amplification module, the ADC module and the MCU are connected in sequence; the signal receiving portion is configured to acquire a frequency response signal of an underground medium through the grounding electrode M and the grounding electrode N, such that the frequency response signal is sequentially subjected to signal pre-amplification, signal conditioning, ADC conversion and post-processing by the MCU, so as to form spectrum characteristic information of the formation outcrop or the rock mass within a preset frequency bandwidth.

2. The device of claim 1, further comprising:
a communication module;
a display module;
a keyboard module; and
a storage module;
wherein the MCU is connected to the communication module, the display module, the keyboard module and the storage module.

3. The device of claim 1, wherein the signal transmission portion is configured to generate an excitation signal at a frequency point of 2″ Hz, and n is an integer selected from −7 to 10; a 0.5-time frequency within the preset frequency bandwidth is configured to perform frequency encryption among each frequency point; and a final signal frequency range is 0.01 Hz-1 kHz.

4. The device of claim 1, wherein the signal transmission portion is in a common clock mode with the signal receiving portion, such that signal transmission and signal receiving are completed based on the common clock mode, thereby detecting amplitude frequency information and phase frequency information of the formation outcrop or the rock mass on the basis of improving an anti-interference capability.

5. The device of claim 1, wherein the grounding electrode A, the grounding electrode B, the grounding electrode C and the grounding electrode D are arranged in a symmetrical quadrupole arrangement, such that the spectrum parameters of the formation outcrop or the rock mass at different depths within a preset depth range are observed by changing a geometric dimension of the grounding electrode A, the grounding electrode B, the grounding electrode C and the grounding electrode D.

6. A method for measuring spectrum parameters of a formation outcrop and a rock mass using the device of claim 1, comprising:
(1) selecting the formation outcrop or the rock mass as an observation object according to an exploration target requirement and a working area; lowering a grounding resistance of the grounding electrode A and the grounding electrode B by watering; connecting a first connecting wire to the grounding electrode A and the grounding electrode B to form a first connecting loop; measuring a first resistance value of the first connecting loop to estimate an output constant current or an output constant voltage; arranging the grounding electrode M and the grounding electrode N according to a requirement of a symmetrical quadrupole arrangement; connecting the grounding electrode M to a terminal of an M port of the device through a second connecting wire; and connecting the grounding electrode N to a terminal of an N port of the device through the second connecting wire to form a second connecting loop;
(2) connecting an external direct current (DC) power supply to an input end of the power amplification module followed by polarity correctness check; and connecting the first connecting wire to terminals of an output end A and an output end B of the power amplification module;
(3) powering on the device for preheating; and checking a connection status of the input end, the output end A and the output end B of the power amplification module, the grounding electrode A, the grounding electrode B, the grounding electrode M, the grounding electrode N, the first connecting wire and the second connecting wire; measuring a second resistance value of the first connecting loop; checking a connection status of the second connecting wire, the grounding electrode M and the grounding electrode N; measuring a resistance value of the second connecting loop;
(4) after preheating the device for 5 min, generating and transmitting, by the signal transmission portion, a 1 Hz excitation signal, and observing and calculating a resistivity value of the observation object at this time; adjusting, by the signal transmission portion, an intensity of the output constant voltage or the output constant current; and sending out, by the signal transmission portion, each frequency point signal in the preset frequency bandwidth set by a frequency table in sequence;
(5) picking up, by the signal transmission portion, the frequency response signal followed by checking to conform that the frequency response signal is normal; and starting acquisition;
(6) saving information of each frequency point received by the signal receiving portion and current information sent by the signal transmission portion in the storage module; and
(7) performing mapping processing in an upper computer followed by corresponding geological interpretation.

7. The device of claim 6, wherein in step (1), in a case where the observation object is a complete rock mass, a dough with a saturated copper sulfate solution is adopted as a coupling material coupled to the grounding electrode A, the grounding electrode B and the complete rock mass, thereby lowering the grounding resistance.
